(19) United States
(12) Patent Application Publication
(10) Pub. No.: US 2024/0301866 A1
(43) Pub. Date: Sep. 12, 2024

(54) HYBRID MODULAR POWER SYSTEM AND METHOD WITH SMART CONTROL

(71) Applicant: HCI Energy, LLC, Kansas City, MO (US)

(72) Inventors: Reza Ansari, Shawnee Mission, KS (US); Kevin M Dunagan, Kansas City, MO (US); Brian J Herr, Olathe, KS (US)

(21) Appl. No.: 18/273,704

(22) PCT Filed: Jan. 22, 2021
(86) PCT No.: PCT/US2021/014522

§ 371 Date: Jul. 21, 2023

Related U.S. Application Data
(63) Continuation-in-part of application No. 16/460,360, filed on Jul. 2, 2019, now abandoned.
Application No. 16/460,360 is a continuation-in-part of application No. 15/500,788, filed on Jan. 31, 2017, now Pat. No. 10,367,442.
Application No. 15/500,788 is a continuation-in-part of application No. 14/883,335, filed on Oct. 14, 2015, now Pat. No. 9,780,720.
Application No. PCT/US2016/057179 is a continuation-in-part of application No. 14/883,335, filed on Oct. 14, 2015, now Pat. No. 9,780,720.
Application No. 14/883,335 is a continuation-in-part of application No. 13/769,113, filed on Feb. 15, 2013, now Pat. No. 9,221,136.
(60) Provisional application No. 61/600,094, filed on Feb. 17, 2012.

(51) Int. Cl. F03D 9/00; F03D 13/20; H01Q 1/12; H02K 7/18; H02S 10/12

(52) U.S. Cl. CPC F03D 9/007; F03D 13/2005; H01Q 1/1235; H02K 7/1815; H02S 10/12; F05B 2220/708; F05B 2240/913

(57) ABSTRACT

A hybrid modular power system with smart control includes a housing configured for containing multiple power modules. A smart control subsystem manages and balances electrical power input from multiple power sources, including a photovoltaic solar panel array subsystem, a wind turbine subsystem, a genset and a battery array. A mast mounted on said housing is configured for mounting a wind turbine, telecommunications antennae, or both. A method of providing electrical power includes the steps of installing multiple power modules in a housing and managing multiple power sources with a smart control subsystem.

### CROSS-REFERENCE TO THE RELATED APPLICATION

This application is a 371 national stage filing and claims priority in International Application No. PCT/US2021/014522 Filed Jan. 22, 2021, which is a continuation-in-part of and claims priority in U.S. patent application Ser. No. 16/460,360, filed Jul. 2, 2019, which is a continuation-in-part of and claims priority in U.S. patent application Ser. No. 15/500,788, filed Jan. 31, 2017, which claims priority in International Application No. PCT/US2016/057179, filed Oct. 14, 2016, and is also a continuation-in-part of and claims priority in U.S. patent application Ser. No. 14/883,335, filed Oct. 14, 2015, which is a continuation-in-part of and claims priority in U.S. patent application Ser. No. 13/769,113, filed Feb. 15, 2013, now U.S. Pat. No. 9,221,136, which claims priority in U.S. Provisional Patent Application No. 61/600,094, filed Feb. 17, 2012, all of which are incorporated herein by reference.

### BACKGROUND OF THE INVENTION

### 1. Field of the Invention

The present invention relates generally to power modules, and in particular to a scalable hybrid modular power system and method with a programmable smart control subsystem.

### 2. Description of the Related Art

Conventional electrical power services are often unavailable at remote locations. Moreover, they are susceptible and vulnerable to service interruptions. For example, natural disasters often interrupt electrical power services by disabling power generation, transmission and delivery infrastructure. Other applications include construction projects at remote locations, disaster recovery efforts and military operations.

Such systems are preferably self-contained and capable of providing output without resource input. For example, solar and wind energy sources can be effectively deployed. Such renewable energy sources can be supplemented as necessary by generators, which can be contained with their fuel tanks in housings or containers along with other components to provide standalone modules for delivering electrical power. Such systems can optionally be connected to electrical power grids, e.g., for recharging the batteries when such external grids are operational. By using such multiple energy sources, the present invention can provide essentially uninterrupted power, which is a criterium for many applications.

Transportability is another criterium for some power modules, particularly those designed for deployment in remote locations. Healthcare, including medical, dental and veterinary, can effectively be provided globally by the World Health Organization (WHO), Doctors without Borders, the International Red Cross and similar medical care providers using the modular power system of the present invention. Alternatively, power modules can be configured for permanent installation supporting a variety of functions, including communications.

### BRIEF DESCRIPTION OF THE DRAWINGS

The drawings constitute a part of this specification and include exemplary embodiments of the present invention illustrating various objects and features thereof.

FIG. 1 is an upper, perspective view of a hybrid modular power system 2 embodying an aspect of the present invention.

FIG. 2 is an exploded view of the system.

FIG. 3 is another, exploded view of the system, shown from a different viewpoint than FIG. 2.

FIG. 4 is an enlarged, perspective view of a generator (genset) and fuel tank taken generally within circle 4 in FIG. 2.

FIG. 5 is a diagram of the system showing the operational relationships of the components.

FIG. 6 is a schematic diagram of the generator (genset) energy source components of the system.

FIG. 7 is a schematic diagram of the renewable (solar and wind) energy source components of the system.

FIG. 8 shows a telecommunications-enabled hybrid modular power system 102 comprising a modified or alternative embodiment of the present invention.

### DETAILED DESCRIPTION OF THE PREFERRED EMBODIMENTS

### I. Hybrid Modular Power System 2; General Description

The embodiments discussed herein are merely illustrative of specific manners in which to make and use the invention and are not to be interpreted as limiting the scope of the instant invention.

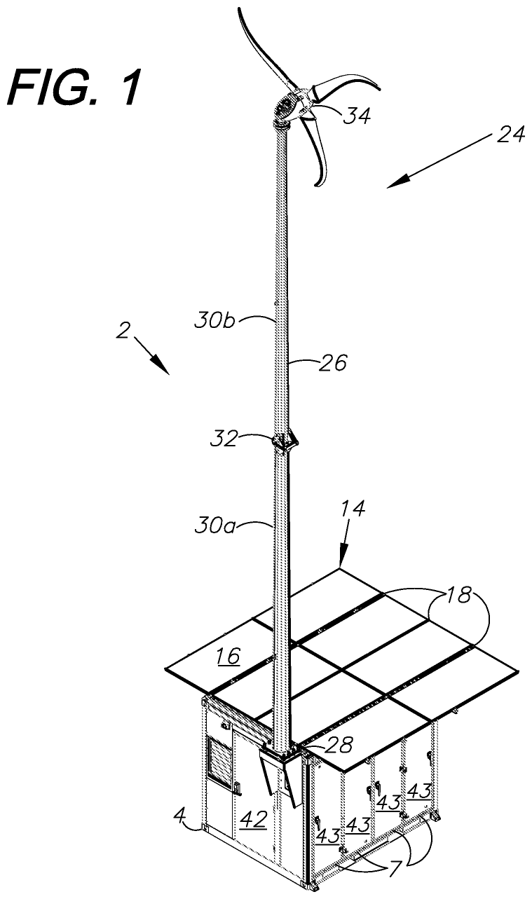

FIG. 1 shows a hybrid modular power system 2 embodying an aspect of the present invention. Without limitation, a housing or container 4 is shown for a multi-user or multi-tenant application with four individual power modules 7, each enclosed within a respective cabinet 6. The housing 4 and the hybrid modular power system 2 are scalable as needed for various applications and users. For example, individual tenants can specify custom power module configurations, capacities, telecommunications, energy modes, microprocessor-based operating systems, etc. Relatively large-scale housings can comprise standard-dimension shipping containers, which are compatible with intermodal transportation, including: container ships; railcars, over-the-road trucks and trailers, etc. Housings with smaller footprints can also accommodate the power module 2 in scaled-down applications.

FIG. 1 shows the system 2 with photovoltaic panel array 14 and wind turbine 24 renewable energy source subsystems deployed. The photovoltaic panel array 14 generally comprises an array of individual photovoltaic panels 16, which optionally can be hingedly connected along fold lines 18, whereby the array 14 can be compactly folded for transport, compact storage, etc. The panel array 14 is shown in a horizontal planar orientation, which would optimize electrical output in locations near the equator. Optionally, the array 14 can be tilted to sloping orientations for optimizing solar radiation reception and corresponding electrical current output.

The wind turbine energy source subsystem 24 includes a mast 26 with a mast mount 28 attached to the housing 4. The mast mount 28 accommodates raising and lowering the mast 26, which could be accomplished with a hoist mechanism similar to that shown in U.S. patent Publication Ser. No. 16/460,360, which is incorporated herein by reference. The mast 26 can comprise multiple sections, e.g., 2 are shown comprising proximate and distal sections 30a,b interconnected by a mast section hinge 32. For storage and transport, the mast 26 can be folded double and laid atop the housing 4.

A wind turbine 34 is mounted on top of the mast 26 and is configured for pivoting to an upwind orientation for optimizing electrical output. Wind turbine 34 output is also a function of elevation. Multiple mast sections 30 can be provided for positioning the wind turbine 34 at an optimal elevation above grade. Moreover, the housing 4 can be installed on top of a base structure, such as another hybrid modular power system 2. In other words, the housings 4 are configured for stacking. The mast 26 is also configured for mounting antennae for the telecommunications component 12, as shown in U.S. patent Publication Ser. No. 16/460,360.

### II. Housing 4

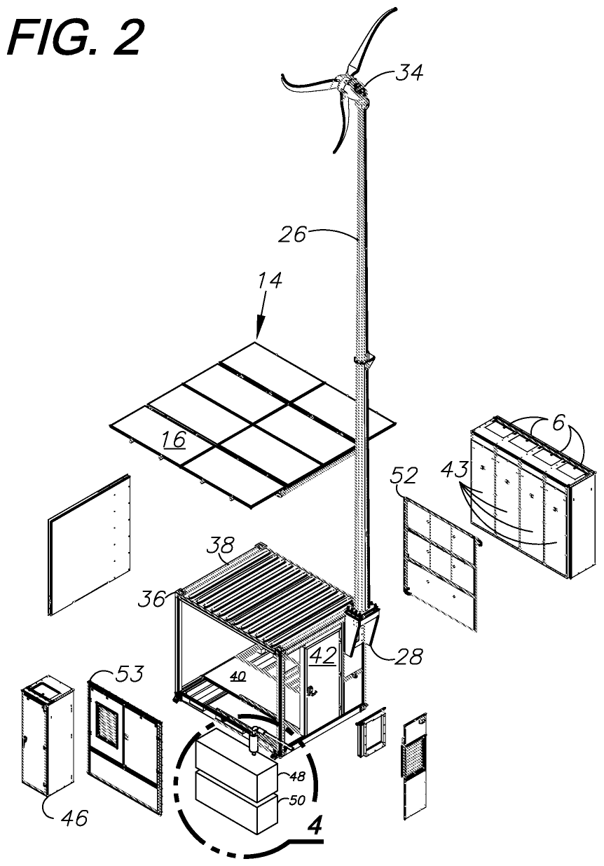

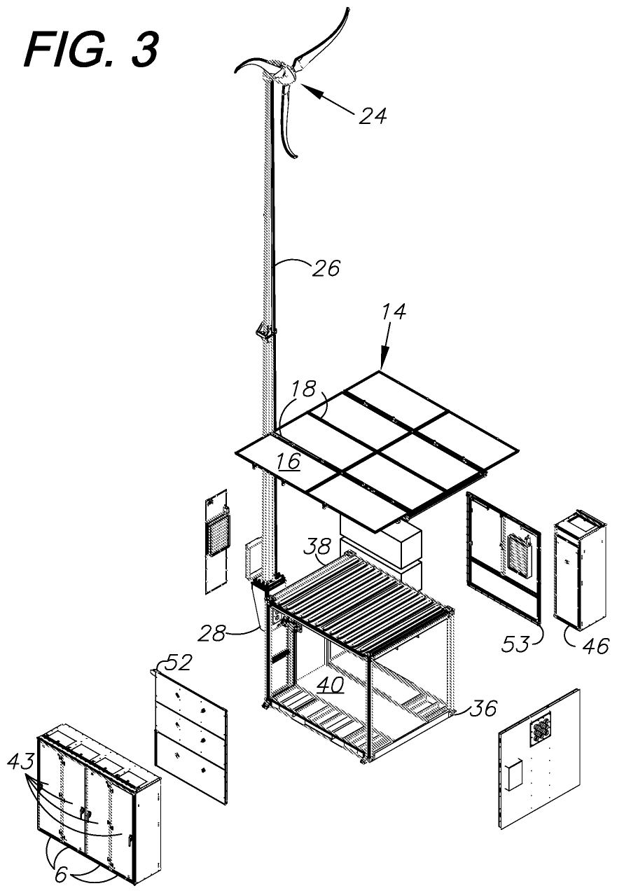

FIGS. 2 and 3 show exploded views of the housing 4, which includes a housing frame 36, a roof 38 and a floor 40. A side door 42 provides access to the housing interior, which can contain multiple (e.g., four are shown) cabinets 6 for accommodating equipment specific to the individual requirements of multiple tenants. The individual power modules 7 can be accessed through respective power module doors 43. The doors 43 can be equipped with keyed locks, card-based radio frequency identification (RFI) locks, combination locks and other security measures to limit access to the individual power modules 7. For example, in a multi-tenant facility, each tenant's access can be restricted to its power module 7 and other tenant-specific components on an as-needed basis.

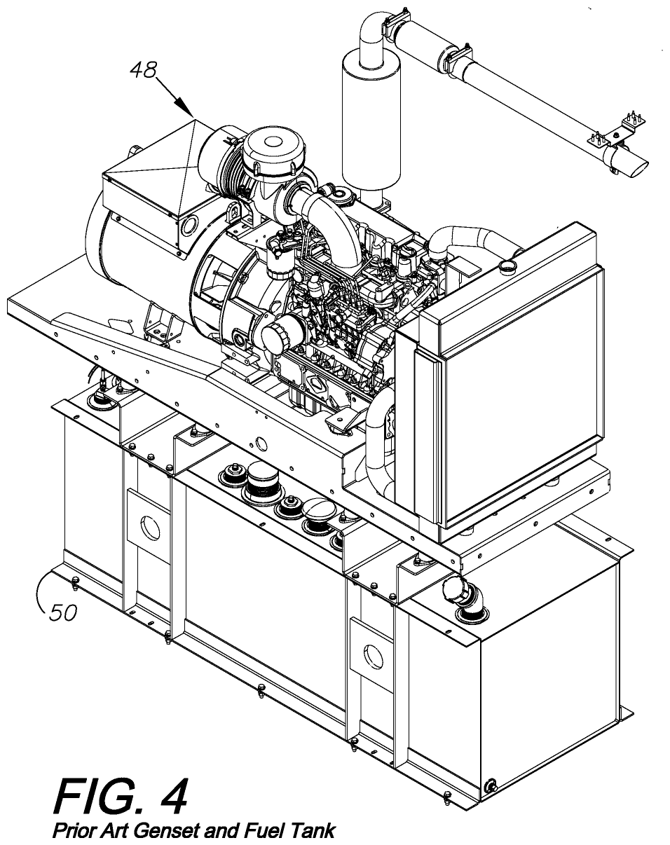

A power conversion cabinet 46 is also located in the housing interior and contains electrical components for converting and transforming the power inputs (e.g., one or more of solar, wind, battery, genset and grid sources) to electrical power in forms required by particular user and customer applications. For example, customers' electrical power requirements can vary considerably, including power levels, AC or DC, two-phase or three-phase AC, voltage, peak vs. non-peak fluctuations, constant or intermittent load demands, varying power usage cycles, etc. The control subsystem 8 can be pre-programmed to manage, balance and adjust the output power and form to accommodate such user needs with the power conversion components in the cabinet 46. A genset 48 is installed on top of a fuel tank 50 (FIG. 4) in the interior of the housing 4. The hybrid modular power system can include multiple gensets for producing AC/DC current at various voltages to accommodate different electrical load requirements. The housing 4 interior can be partitioned with internal wall panels, such as the genset panel 52. Additional panels, such as external vented genset panel 53, can be installed as needed.

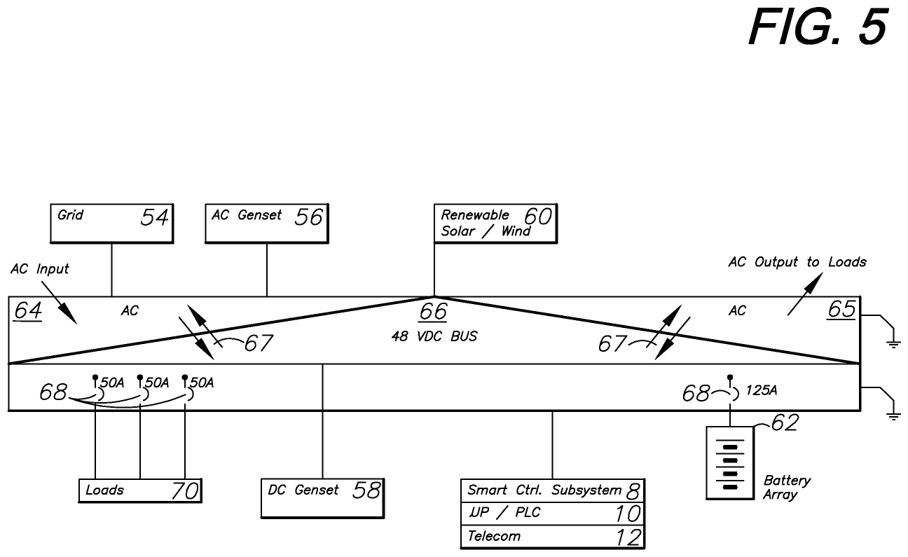

### III. System 2 Schematics (FIGS. 5-7)

As shown in FIG. 5, the system 2 includes a smart control subsystem 8 with a microprocessor or programmable logic controller (PLC) 10 and a telecommunications (telecom) component 12. The telecom component 12 can accommodate wireless telecommunications via satellites and direct transmission. The system 2, via the telecom component 12, can also accommodate hardwired (landline) service. Electrical sources providing inputs to the system 2 include the grid 54, an AC genset 56, a DC genset 58, renewable energy inputs (e.g., solar and wind, collectively 60) and a battery array 62. Without limitation, the batteries can be lithium ion for performance, recharging and service life characteristics. FIG. 5 schematically shows examples of inputs and outputs to the system 2. Without limitation, AC and DC input current is received at 64, 66, respectively. AC current is output to loads at 65. Optionally, the control system 8 can convert AC to DC, and vice versa to dynamically accommodate and balance available inputs with load demands, as indicated by the directional current flow arrows 67. The control subsystem 8 can include electrical circuit breakers 68 and a surge protection device (SPD) 72 with suitable ratings for accommodating various loads 70, the battery array 62 and other electrical connections for overload protection of the system 2 components.

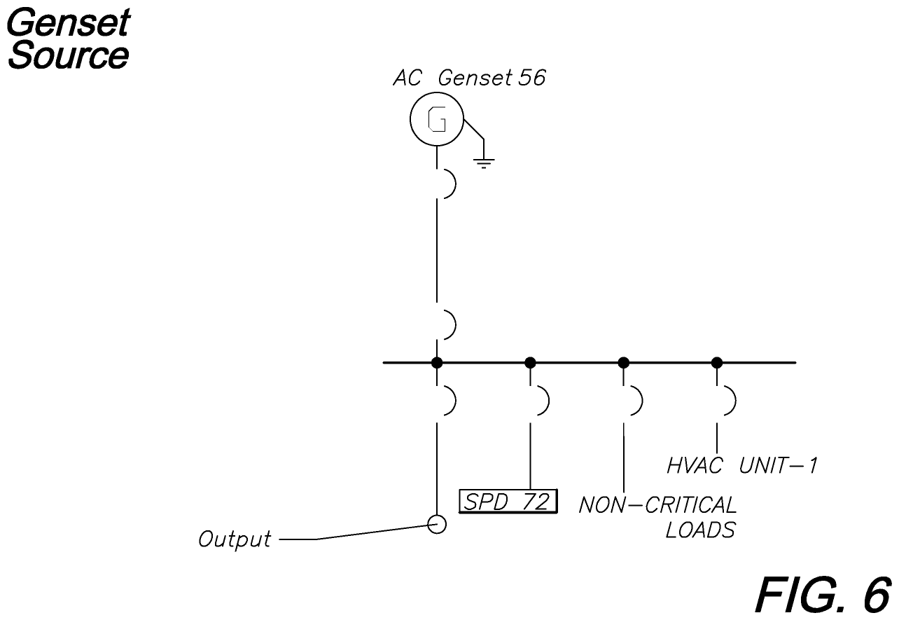

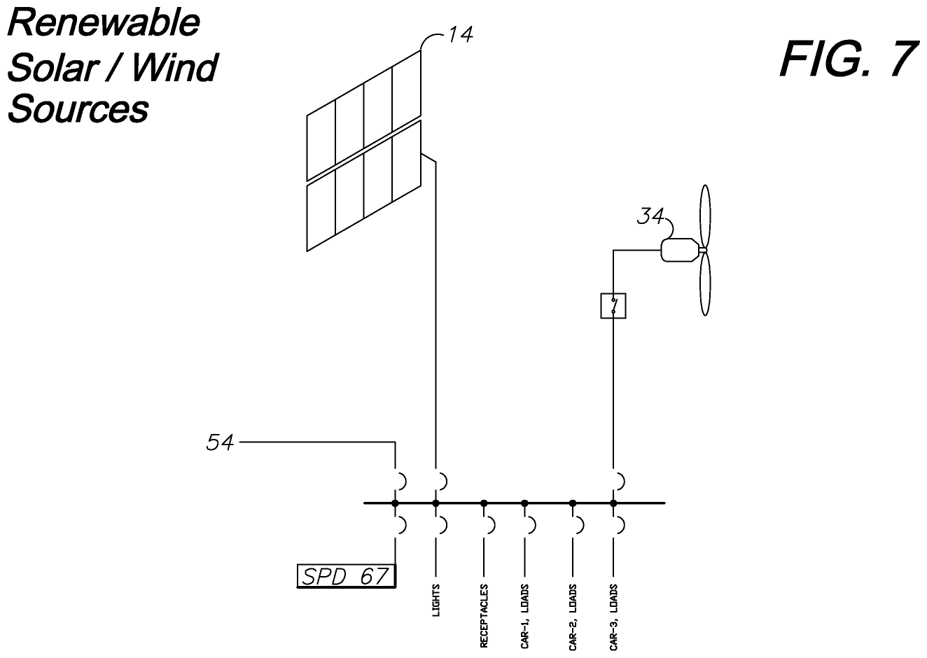

FIG. 6 shows the AC genset source 56 and connections to the system 2. FIG. 7 shows connections to the system 2 for the renewable solar and wind electrical power sources 14 and 24, respectively.

### IV. Hybrid Modular Power System 2 Method and Operation

In operation, the system 2 can be configured for transportation by truck, rail, marine vessel or air. Remote, off-grid locations can thus be served by the system 2. Moreover, the system 2 can be relocated as necessary. Examples of relatively permanent installations include telecommunications equipment sites. Relatively temporary installations include construction sites. Moreover, rapid-response electrical power needs can be accommodated by transporting the system 2, e.g., for responding to crises and natural disasters.

One or more compartments 6 can accommodate personnel and equipment specific for procedures and activities as required by the tenants. For example, with proper equipment medical, dental and veterinary clinical procedures can be accommodated in remote, off-grid locations and elsewhere.

### V. Alternative Embodiment Hybrid Modular Power System 102

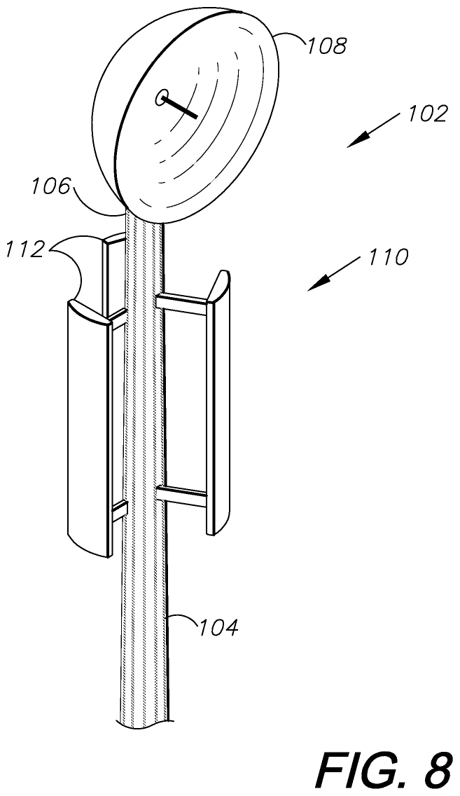

FIG. 8 shows a telecommunications-enabled hybrid modular power system 102 comprising a modified or alternative embodiment of the present invention. A mast 104 includes a distal end 106 mounting a parabolic reflector microwave antenna 108, which can be oriented for focused, linear transmission and reception, e.g., signal transmission to and from another microwave antenna. An antenna array 110 comprising multiple individual antenna units 112 is mounted below the parabolic reflector antenna 108. The antenna units 112 are mounted in radially-spaced relation around the mast 104.

The hybrid modular power systems 2 and 102 can be configured with additional combinations of wind turbines and antennae to accommodate the requirements of the hybrid power module tenants and users. For example, a wind turbine can be mounted on the mast distal end, with antennae located below.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A hybrid modular power system comprising:
a housing with an interior;
a control subsystem including a microprocessor;
a power module in said interior;
said power module connected to said control subsystem;
one or more power sources chosen from the group comprising: a wind turbine; a photovoltaic solar panel array; an electrical storage battery; a generator; and an electrical grid;
a mast having a proximate end pivotally attached to said housing and a distal end;
said mast mounting one or more of a wind turbine and an antenna for a telecommunications subsystem connected to said control subsystem;
said mast being pivotable between a lowered position adjacent said housing and a raised position extending upwardly therefrom; and
said control subsystem configured for managing power input to said power module from said power sources and managing power output to an electrical power load.

2. The system according to claim 1 wherein said electrical power sources include a photovoltaic solar array mounted on top of said housing and connected to said control subsystem.

3. The system according to claim 2, wherein said solar array is configured for unfolding to a generally flat use position and folding to a folded storage position for transport.

4. The system of claim 1, which includes:
said telecommunications subsystem is configured for transmitting system status information from said control subsystem and receiving system operating instructions for said control subsystem.

5. The system of claim 1, which includes multiple antennae mounted on said mast.

6. The system of claim 5 wherein said antennae include:
a parabolic reflector microwave antenna mounted on top of said mast; and
an antenna array comprising multiple elements mounted at radially-spaced positions around said antenna below said parabolic reflector antenna.

7. The system of claim 1, which includes:
a mast mounting subassembly including a bracket pivotally connecting said housing to said mast proximate end; and
said mast and configured for raising said mast from a lowered position adjacent to said housing to a raised position extending from said housing.

8. The system of claim 7, which includes:
said mast including a proximate section with said mast proximate end and a distal section with said mast distal end;
a mast section hinge pivotally connecting said mast proximate and distal sections; and
said mast configured for folding about said mast section hinge between a folded, transport storage position and an unfolded, extended use position with said mast sections longitudinally aligned.

9. The system of claim 1 wherein said power sources include:
a genset with an internal combustion engine driving an electrical generator;
a fuel tank connected to said genset; and
said fuel tank mounted in said housing with said genset mounted on top of said fuel tank.

10. The system of claim 9 wherein said genset produces alternating current (AC) electrical power.

11. The system of claim 9 wherein said genset produces direct-current (DC) electrical power.

12. The system of claim 1, which includes multiple said power modules mounted in said housing.

13. The system of claim 12 wherein each said power module is utilized by a respective tenant and contains tenant-specific components.

14. A hybrid modular power system comprising:
a housing with an interior;
a control subsystem including a microprocessor;
a power module in said interior;
said power module connected to said control subsystem;
one or more power sources chosen from the group comprising: a wind turbine; a photovoltaic solar panel array; an electrical storage battery; a generator; and an electrical grid;
a mast having a proximate end pivotally attached to said housing and a distal end;
said mast being pivotable between a lowered position adjacent said housing and a raised position extending upwardly therefrom;
a mast mounting subassembly including a bracket pivotally mounting said mast proximate end;
said mast mounting one or both of a wind turbine and an antenna for a telecommunications subsystem connected to said control subsystem;
said control subsystem configured for managing power input to said power module from said power sources and managing power output to an electrical power load;
said photovoltaic solar array being mounted on top of said housing and connected to said control subsystem;
said solar array being configured for unfolding to a generally flat use position and folding to a folded storage position for transport;
said telecommunications subsystem being configured for transmitting system status information from said control subsystem and receiving system operating instructions for said control subsystem;
a parabolic reflector microwave antenna mounted on top of said mast;
an antenna array comprising multiple elements mounted at radially-spaced positions around said antenna below said parabolic reflector antenna;
said mast including a proximate section with said mast proximate end and a distal section with said mast distal end mounting subassembly including a bracket pivotally connecting said housing to said mast proximate end;
a mast section hinge pivotally connecting said mast proximate and distal sections;
said mast configured for folding about said mast section hinge between a folded, transport storage position and an unfolded, extended use position with said mast sections longitudinally aligned;
said power sources including a genset with an internal combustion engine driving an electrical generator;
a fuel tank connected to said genset;
said fuel tank mounted in said housing with said genset mounted on top of said fuel tank; and
multiple power modules mounted in said housing, each power module utilized by a respective tenant and containing tenant-specific components.

15. The system of claim 14 wherein said genset produces alternating current (AC) electrical power.

16. The system of claim 14 wherein said genset produces direct-current (DC) electrical power.

17. A hybrid modular power method comprising the steps of:
providing a housing with an interior;
providing a control subsystem including a microprocessor;
providing a power module in said interior;
connecting said power module to said control subsystem;
providing one or more power sources chosen from the group comprising: a wind turbine; a photovoltaic solar panel array; an electrical storage battery; a generator; and an electrical grid;
providing a mast having a proximate end pivotally attached to said housing and a distal end;
mounting on said mast one or more of a wind turbine and an antenna for a telecommunications subsystem connected to said control subsystem;
pivotally moving said mast between a lowered position adjacent said housing and a raised position extending upwardly therefrom; and
said control subsystem managing power input to said power module from said power sources and managing power output to an electrical power load.

18. The method of claim 17, which includes the additional step of providing multiple said power modules mounted in said housing.

19. The method of claim 18, which includes the additional steps of configuring each said power module for use by a respective tenant and placing tenant-specific components in each said power module.

20. The method of claim 17, which includes the additional step of monitoring and balancing electrical power usage by multiple loads with said control subsystem.
